(19) United States
(12) Patent Application Publication
(10) Pub. No.: US 2026/0360304 A1
(43) Pub. Date: Nov. 12, 2026

(54) DISPLAY DEVICE AND ELECTRONIC DEVICE INCLUDING THE SAME

(71) Applicants: Samsung Display Co., Ltd., Yongin-si (KR); SEOUL NATIONAL UNIVERSITY R&DB FOUNDATION, Seoul (KR)

(72) Inventors: SEHYUN LEE, Yongin-si (KR); Saeru Cheon, Seoul (KR); Soo-Yeon Lee, Seoul (KR); KYUNGHOON CHUNG, Yongin-si (KR); KWIHYUN KIM, Yongin-si (KR)

(21) Appl. No.: 19/576,838

(22) Filed: Mar. 24, 2026

(30) Foreign Application Priority Data
May 12, 2025 (KR) 10-2025-0061337

(51) Int. Cl. G09G 3/32; G09G 3/3266; G09G 3/3291

(52) U.S. Cl. CPC G09G 3/32; G09G 3/3266; G09G 3/3291; G09G 2310/0267; G09G 2310/0275; G09G 2320/045

(57) ABSTRACT

A display device includes a display panel including a pixel circuit, a gate emission driver configured to output a gate emission signal to the pixel circuit, a sweep signal generator configured to generate a sweep signal based on the gate emission signal, a data driver configured to apply a data voltage to the pixel circuit and a driving controller configured to control the gate emission driver, the sweep signal generator and the data driver. The sweep signal generator outputs the sweep signal to the pixel circuit through a sweep line. The sweep line is connected to a compensation capacitor. The compensation capacitor receives a compensation voltage. The compensation voltage is generated based on the data voltage.

### CROSS REFERENCE TO RELATED APPLICATIONS

This application claims priority to Korean Patent Application No. 10-2025-0061337, filed on May 12, 2025 and all the benefits accruing therefrom under 35 U.S.C. §119, the content of which in its entirety is herein incorporated by reference.

### BACKGROUND

### 1. Field

Embodiments of the present invention relate to a display device and an electronic device including the same. More particularly, embodiments of the present invention relate to a display device which generates a sweep signal and an electronic device including the same.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver for providing a gate signal to the gate lines, a data driver for providing a data voltage to the data lines, an emission driver for providing an emission signal to the emission lines and a driving controller controlling the gate driver, the data driver and the emission driver.

A display device may display an image by driving a light emitting element, such as a micro-light emitting diode (“micro-LED”) or an organic light emitting diode (“OLED”), according to a pulse amplitude modulation (“PAM”) method or a pulse width modulation (“PWM”) method, for example. In the PAM method, a gray level may be represented by adjusting an amount (or an amplitude) of an emission current provided to the light emitting element. In the PWM method, the gray level may be represented by adjusting a time period (or a pulse width) during which the emission current is provided to the light-emitting element.

A wavelength of light emitted by the light-emitting element such as the micro-LED may be shifted according to the amount of the emission current. Thus, in a case where the light-emitting element such as the micro-LED is driven in the PAM method, for example, a color shift phenomenon may occur, and the image may be distorted.

### SUMMARY

Embodiments of the present invention provide a display device which generates a sweep signal for driving a light emitting element in a pulse width modulation (“PWM”) method.

Embodiments of the present invention provide an electronic device including the display device.

According to embodiments, a display device includes a display panel including a pixel circuit, a gate emission driver configured to output a gate emission signal to the pixel circuit, a sweep signal generator configured to generate a sweep signal based on the gate emission signal, a data driver configured to apply a data voltage to the pixel circuit and a driving controller configured to control the gate emission driver, the sweep signal generator and the data driver. The sweep signal generator outputs the sweep signal to the pixel circuit through a sweep line. The sweep line is connected to a compensation capacitor. The compensation capacitor receives a compensation voltage. The compensation voltage is generated based on the data voltage.

In an embodiment, the compensation voltage may be generated based on an average value of a data voltage group applied to a pixel-row.

In an embodiment, the display panel may include first to N-th pixel-rows and N may be a natural number greater than 1. The compensation voltage may be generated based on a first average value of a first data voltage group applied to the first pixel-row and a second average value of a second data voltage group applied to the second pixel-row.

In an embodiment, the compensation voltage may be generated based on a difference between the first average value and the second average value.

In an embodiment, the compensation voltage may be generated based on a value obtained by multiplying a compensation constant and the difference between the first average value and the second average value.

In an embodiment, the compensation constant may be determined based on a capacitance of the compensation capacitor.

In an embodiment, the display panel may further include first to N-th sweep lines. The first sweep line may be connected to the first pixel-row, the second sweep line may be connected to the second pixel-row, and the third sweep line may be connected to the third pixel-row. The first sweep line may receive a first compensation voltage through a first compensation capacitor, the second sweep line may receive a second compensation voltage through a second compensation capacitor, and the third sweep line may receive a third compensation voltage through a third compensation capacitor. The first compensation voltage may be generated based on the first average value and the second average value. The second compensation voltage may be generated based on a third average value of a third data voltage group applied to the third pixel-row and the second average value.

In an embodiment, the display panel may include first to N-th pixel-rows and first to N-th sweep lines. The first sweep line may be connected to the first pixel-row, and the second sweep line may be connected to the second pixel-row. The first sweep line may receive a first compensation voltage through a first compensation capacitor, and the second sweep line may receive a second compensation voltage through a second compensation capacitor. The first compensation voltage may be a first average value of a first data voltage group applied to the first pixel-row. The second compensation voltage may be a second average value of a second data voltage group applied to the second pixel-row.

In an embodiment, the driving controller may output compensation voltage data to the gate emission driver based on the data voltage. The gate emission driver may output the compensation voltage to the sweep line.

In an embodiment, the pixel circuit may include a first circuit which outputs a pulse control signal based on the gate emission signal and the sweep signal, a second circuit which generates a driving current based on the pulse control signal and the gate emission signal, a third circuit which is connected to the sweep line and outputs the sweep signal to the first circuit and a light emitting element which emits light based on the driving current. The third circuit may include a diode element.

According to embodiments, a display device includes a display panel including a pixel circuit, a gate emission driver configured to output a gate emission signal to the pixel circuit, a sweep signal generator configured to generate a sweep signal based on the gate emission signal, a data driver configured to apply a data voltage to the pixel circuit and a driving controller configured to control the gate emission driver, the sweep signal generator and the data driver. The sweep signal generator outputs the sweep signal to the pixel circuit through a sweep line. The pixel circuit includes a first circuit which outputs a pulse control signal based on the gate emission signal and the sweep signal, a second circuit which generates a driving current based on the pulse control signal and the gate emission signal, a third circuit which is connected to the sweep line and outputs the sweep signal to the first circuit and a light emitting element which emits light based on the driving current. The third circuit includes a diode element.

In an embodiment, wherein the diode element may be a diode transistor. The diode transistor may include a control electrode, a first electrode connected to the sweep line and a second electrode connected to the control electrode. The second electrode may output the sweep signal.

In an embodiment, the diode element may include a first diode transistor and a second diode transistor. The first diode transistor and the second diode transistor may be connected in series.

In an embodiment, the first diode transistor may include a control electrode, a first electrode connected to the sweep line and a second electrode connected to the control electrode of the first diode transistor. The second diode transistor may include a control electrode, a first electrode connected to the second electrode of the first diode transistor and a second electrode connected to the control electrode of the second diode transistor. The second electrode of the second diode transistor may output the sweep signal.

According to embodiments, an electronic device includes a display panel including a pixel circuit, a gate emission driver configured to output a gate emission signal to the pixel circuit, a sweep signal generator configured to generate a sweep signal based on the gate emission signal, a data driver configured to apply a data voltage to the pixel circuit, a driving controller configured to control the gate emission driver, the sweep signal generator and the data driver based on an input control signal and a processor configured to output the input control signal. The sweep signal generator outputs the sweep signal to the pixel circuit through a sweep line. The sweep line is connected to a compensation capacitor. The compensation capacitor receives a compensation voltage. The compensation voltage is generated based on the data voltage

In an embodiment, the display panel may include first to N-th pixel-rows. The compensation voltage may be generated based on a first average value of a first data voltage group applied to the first pixel-row and a second average value of a second data voltage group applied to the second pixel-row.

In an embodiment, the compensation voltage may be generated based on a difference between the first average value and the second average value.

In an embodiment, the display panel may further include first to N-th sweep lines, and N may be a natural number greater than 1. The first sweep line may be connected to the first pixel-row, the second sweep line may be connected to the second pixel-row, and the third sweep line may be connected to the third pixel-row. The first sweep line may receive a first compensation voltage through a first compensation capacitor, the second sweep line may receive a second compensation voltage through a second compensation capacitor, and the third sweep line may receive a third compensation voltage through a third compensation capacitor. The first compensation voltage may be generated based on the first average value and the second average value. The second compensation voltage may be generated based on a third average value of a third data voltage group applied to the third pixel-row and the second average value.

In an embodiment, the display panel may include first to N-th pixel-rows and first to N-th sweep lines. The first sweep line may be connected to the first pixel-row, and the second sweep line may be connected to the second pixel-row. The first sweep line may receive a first compensation voltage through a first compensation capacitor, and the second sweep line may receive a second compensation voltage through a second compensation capacitor. The first compensation voltage may be a first average value of a first data voltage group applied to the first pixel-row. The second compensation voltage may be a second average value of a second data voltage group applied to the second pixel-row.

In an embodiment, the pixel circuit may include a first circuit which outputs a pulse control signal based on the gate emission signal and the sweep signal, a second circuit which generates a driving current based on the pulse control signal and the gate emission signal, a third circuit which is connected to the sweep line and outputs the sweep signal to the first circuit and a light emitting element which emits light based on the driving current. The third circuit may include a diode element.

As described above, a compensation voltage may be applied to a sweep line to which a sweep signal is applied. The compensation voltage may be determined based on an average value of a data voltage group. Accordingly, an influence of a parasitic voltage due to change in a data voltage may be reduced. For example, the influence of the parasitic voltage may be reduced based on the compensation voltage. Since the influence of the parasitic voltage may be reduced based on the compensation voltage, a signal stability and a signal reliability of the sweep signal may be improved. Accordingly, a display quality of a display panel may be effectively improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present invention.

FIG. 2 is a diagram illustrating an example of an N-th gate emission stage included in a gate emission driver of FIG. 1, an N-th sweep stage included in a sweep signal generator of FIG. 1 and an N-th pixel-row included in a display panel of FIG. 1.

FIG. 3 is a diagram illustrating a parasitic voltage between data lines and sweep lines included in a display panel of FIG. 1.

FIG. 4 is a block diagram illustrating an example of a compensation voltage determining block included in a driving controller of FIG. 1, a gate emission driver of FIG. 1 and a sweep signal generator of FIG. 1.

FIG. 5 is a diagram illustrating an example of an N-th gate emission stage included in a gate emission driver of FIG. 1, an N-th sweep stage included in a sweep signal generator of FIG. 1, and an N-th pixel-row included in a display panel of FIG. 1.

FIG. 6 is a diagram illustrating an example of a method for determining a compensation voltage of FIG. 5.

FIG. 7 is a circuit diagram illustrating an example of an N-th sweep stage of FIG. 5.

FIG. 8 is a circuit diagram illustrating an example of signals applied to an N-th sweep stage of FIG. 7.

FIG. 9 is a graph illustrating a sweep signal according to a comparative example.

FIG. 10 is a graph illustrating a sweep signal applied to a pixel circuit of FIG. 1.

FIG. 11 is a circuit diagram illustrating an example of a pixel circuit of FIG. 1.

FIG. 12 is a circuit diagram illustrating an example of a diode circuit of FIG. 11.

FIG. 13 is a circuit diagram illustrating an example of a diode circuit of FIG. 11.

FIG. 14 is a graph illustrating a sweep signal according to a comparative example and a sweep signal applied to a pixel circuit of FIG. 1.

FIG. 15 is a block diagram illustrating an electronic device according to embodiments of the present invention.

FIGS. 16-18 are schematic diagrams illustrating an electronic device according to embodiments.

### DETAILED DESCRIPTION

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Hereinafter, the present invention will be explained in detail with reference to the accompanying drawings.

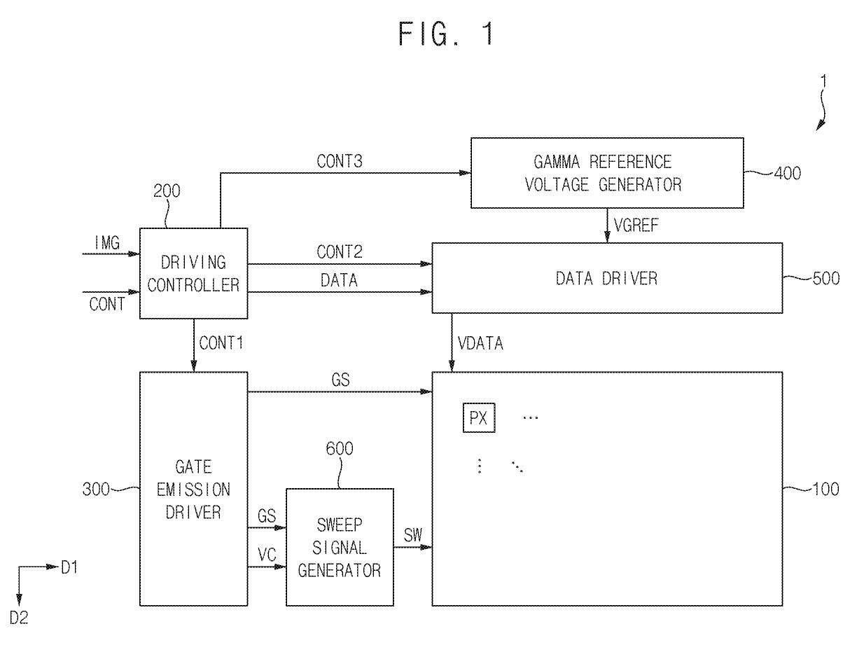

FIG. 1 is a block diagram illustrating a display device 1 according to embodiments of the present invention.

Referring to FIG. 1, an embodiment of the display device 1 may include a display panel 100 and a display panel driver. The display panel driver may include a driving controller 200, a gate emission driver 300, a gamma reference voltage generator 400, a data driver 500 and a sweep signal generator 600.

The display panel 100 may include a display region on which an image is displayed and a peripheral region adjacent to the display region.

The display panel 100 may include a plurality of gate lines GL, plurality of emission lines EL, a plurality of data lines DL and a plurality of pixels electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1. The sweep lines may extend in the first direction D1.

The driving controller 200 may receive input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3 and a data signal DATA based on the input image data IMG and the input control signal CONT. In an embodiment, the driving controller may further generated a fourth control signal based on the input image data IMG and the input control signal CONT.

The driving controller 200 may generate the first control signal CONT1 for controlling an operation of the gate emission driver 300 based on the input control signal CONT, and output the first control signal CONT1 to the gate emission driver 300. The first control signal CONT1 may include a vertical start signal and a gate clock signal.

The driving controller 200 may generate the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

In an embodiment, the driving controller may generate the fourth control signal for controlling an operation of the sweep signal generator 600 based on the input control signal CONT, and output the fourth control signal CONT4 to the sweep signal generator 600.

The gate emission driver 300 may generate gate emission signals GS driving the gate lines GL in response to the first control signal CONT1 received from the driving controller 200. The gate emission driver 300 may output the gate emission signals GS to the gate lines GL. The gate emission signals GS may may include a first scan signal, a second scan signal and an emission signal. The gate emission driver 300 may output the gate emission signal GS and a compensation voltage VC to the sweep signal generator 600.

In the present embodiment, the first control signal CONT1 may include compensation voltage data VCD. The gate emission driver 300 may output the compensation voltage VC corresponding to the compensation voltage data VCD to the sweep signal generator 600.

In an embodiment, the gate emission driver 300 may be disposed in the peripheral region. In an embodiment, the gate emission driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

In an embodiment, the data driver 500 may be disposed in the peripheral region. In an embodiment, the data driver 500 may be integrated in the peripheral region.

The sweep signal generator 600 may generate the sweep signal SW based on the gate emission signal GS and the compensation voltage VC. The sweep signal generator 600 may output the sweep signal SW to the display panel 100. The sweep signal generator 600 may output the sweep signal SW to the pixel circuit PX through the sweep line.

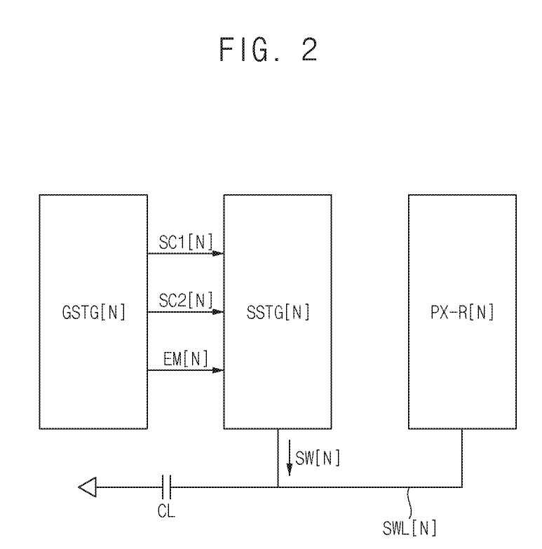

FIG. 2 is a diagram illustrating an example of an N-th gate emission stage GSTG[N] included in a gate emission driver 300 of FIG. 1, an N-th sweep stage included in a sweep signal generator 600 of FIG. 1 and an N-th pixel-row included in a display panel 100 of FIG. 1.

Referring to FIGS. 1 and 2, the gate emission driver 300 may include a plurality of gate emission stages. For example, the gate emission driver 300 may include a plurality of gate emission stages which are located sequentially. The sweep signal generator 600 may include a plurality of sweep stages. For example, the sweep signal generator 600 may include a plurality of sweep stages which are located sequentially. The display panel 100 may include a plurality of pixel-rows. For example, the display panel 100 may include a plurality of pixel-rows which are located sequentially. For example, a first pixel-row may be connected to a first gate emission stage and a first sweep stage. For example, a second pixel-row may be connected to a second gate emission stage and a second sweep stage. For example, a third pixel-row may be connected to a third gate emission stage and a third sweep stage. For example, an N-th pixel row may be connected to an N-th gate emission stage and an N-th sweep stage.

For example, the gate emission driver 300 may include the N-th gate emission stage GSTG[N]. The N-th gate emission stage GSTG[N] may output gate emission signals SC1[N], SC2[N] and EM[N] to the N-th pixel-row PX-R[N]. The N-th gate emission stage GSTG[N] may output gate emission signals SC1[N], SC2[N] and EM[N] to the N-th sweep stage SSTG[N].

The N-th sweep stage SSTG[N] may generate an N-th sweep signal SW[N] based on the gate emission signals SC1[N], SC2[N] and EM[N] received from the N-th gate emission stage GSTG[N]. The N-th sweep stage SSTG[N] may output the N-th sweep signal SW[N] to an N-th sweep line SWL[N]. When the N-th sweep stage SSTG[N] outputs the N-th sweep signal SW[N] to the N-th sweep line SWL[N], the N-th sweep signal SW[N] may be gradually applied by a load capacitor CL. Since the N-th sweep signal SW[N] may be applied gradually by the load capacitor CL, a voltage level of the sweep signal SW may be gradually increased. In an embodiment, since the N-th sweep signal SW[N] may be applied gradually by the load capacitor CL, the voltage level of the sweep signal SW may be gradually decreased.

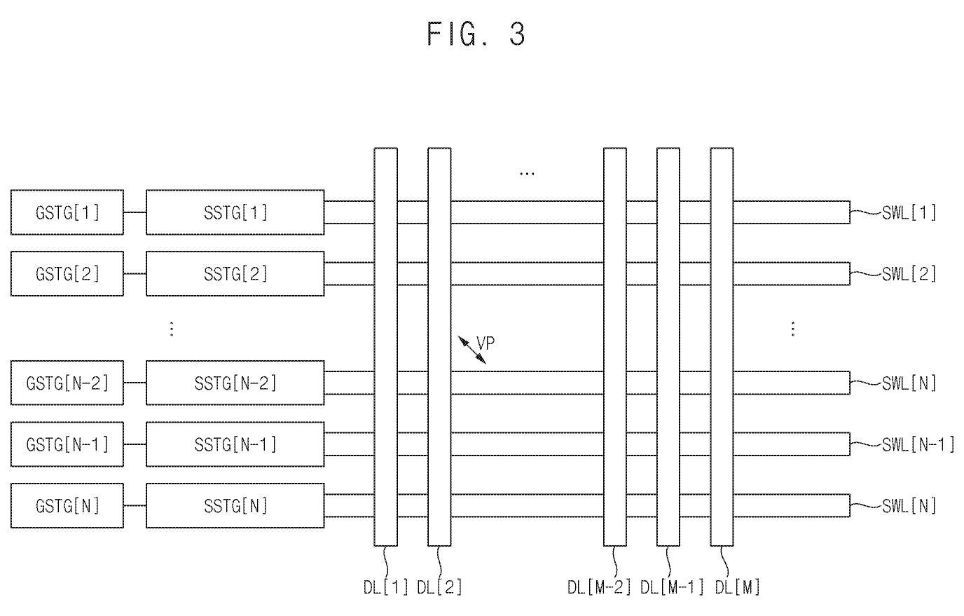

FIG. 3 is a diagram illustrating a parasitic voltage VP between data lines DL[1] to DL[M] and sweep lines SWL[1] to SWL[N] included in a display panel 100 of FIG. 1.

Referring to FIGS. 1-3, the gate emission driver 300 may include the first to N-th gate emissions stages GSTG[1] to GSTG[N]. The sweep signal generator 600 may include the first to N-th sweep stages SSTG[1] to SSTG[N]. The display panel 100 may include first to M-th data lines DL[1] to DL[M]. The display panel 100 may include first to N-th sweep lines SWL[1] to SWL[N].

The first gate emission stage GSTG[1] may be connected to the first sweep stage SSTG[1]. The first sweep stage SSTG[1] may be connected to the first sweep line SWL[1]. The second gate emission stage GSTG[2] may be connected to the second sweep stage SSTG[2]. The second sweep stage SSTG[2] may be connected to the second sweep line SWL[2]. The N-2-th gate emission stage GSTG[N-2] may be connected to the N-2-th sweep stage SSTG[N-2]. The N-2-th sweep stage SSTG[N-2] may be connected to the N-2-th sweep line SWL[N-2]. The N-1-th gate emission stage GSTG[N-1] may be connected to the N-1-th sweep stage SSTG[N-1]. The N-1-th sweep stage SSTG[N-1] may be connected to the N-1-th sweep line SWL[N-1]. The N-th gate emission stage GSTG[N] may be connected to the N-th sweep stage SSTG[N]. The N-th sweep stage SSTG[N] may be connected to the N-th sweep line SWL[N].

The data driver 500 may be connected to the first to M-th data lines DL[1] to DL[M]. For example, the first data line DL[1] may be connected to the first pixel-column. For example, the M-th data line DL[M] may be connected to the M-th pixel-column.

When the data driver 500 outputs the data voltage VDATA to the first to M-th data lines DL[1] to DL[M], a parasitic voltage VP may be generated due to a parasitic capacitance between the data line and the sweep line. For example, a voltage of the sweep line may change based on a change in the data voltage VDATA. For example, the voltage of the sweep line may change by the parasitic voltage VP based on a change in the data voltage VDATA and the parasitic capacitance. Since the voltage of the sweep line may change based on a change in the data voltage VDATA, a signal stability of the sweep signal SW may be deteriorated.

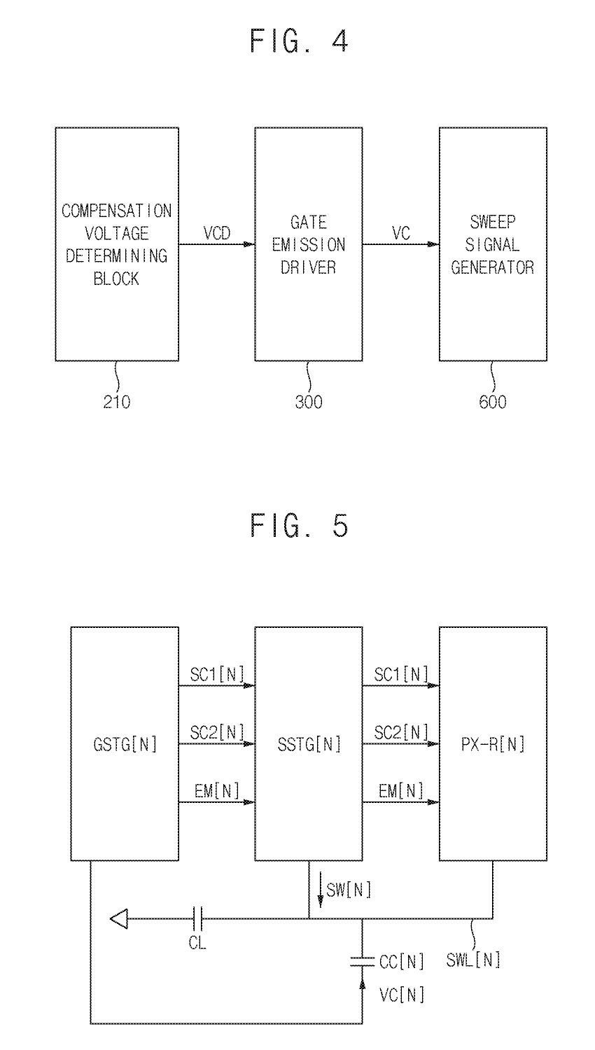

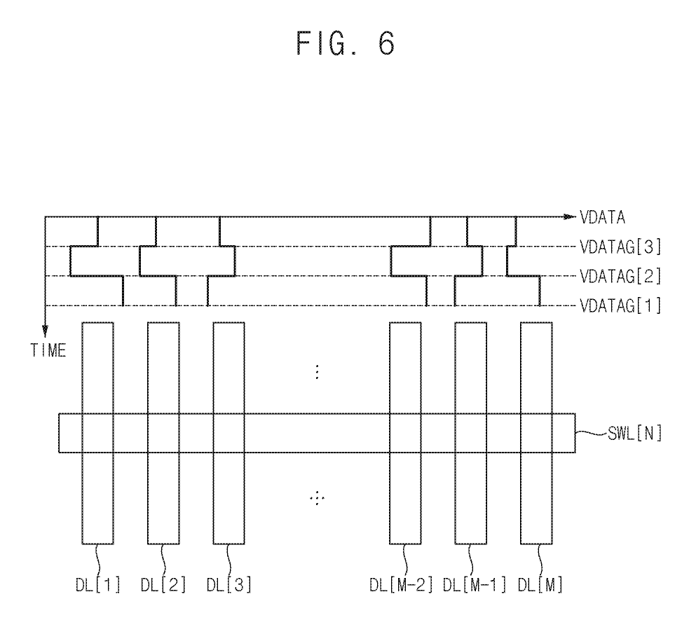

FIG. 4 is a block diagram illustrating an example of a compensation voltage determining block 210 included in a driving controller 200 of FIG. 1, a gate emission driver 300 of FIG. 1 and a sweep signal generator 600 of FIG. 1. FIG. 5 is a diagram illustrating an example of an N-th gate emission stage GSTG[N] included in a gate emission driver 300 of FIG. 1, an N-th sweep stage included in a sweep signal generator 600 of FIG. 1, and an N-th pixel-row included in a display panel 100 of FIG. 1. FIG. 6 is a diagram illustrating an example of a method for determining a compensation voltage VC of FIG. 5.

Referring to FIGS. 1-6, the driving controller 200 may include a compensation voltage determining block 210. The compensation voltage determining block 210 may generate compensation voltage data VCD based on the data voltage VDATA. The compensation voltage determining block 210 may output the compensation voltage data VCD to the gate emission driver 300. The gate emission driver 300 may output the compensation voltage VC to the sweep signal generator 600.

The gate emission driver 300 may apply the compensation voltage VC to the sweep line through a compensation capacitor. The compensation capacitor may include a first electrode for receiving the compensation voltage VC and a second electrode connected to the sweep line. The compensation capacitor CC may apply the compensation voltage VC to the sweep line.

For example, the N-th gate emission stage GSTG[N] may output a first-N-th scan signal SC1[1], a second-N-th scan signal SC2[N] and an N-th emission signal EM[N] to the N-th sweep stage SSTG[N]. The N-th sweep stage SSTG[N] may output the N-th sweep signal SW[N] to the N-th sweep line SWL[N]. The N-th sweep line SWL[N] may be connected to the N-th pixel-row PX-R[N]. For example, the N-th gate emission stage GSTG[N] may apply an N-th compensation voltage VC[N] to an N-th compensation capacitor CC[N]. The N-th compensation capacitor CC[N] may apply the N-th compensation voltage VC[N] to the N-th sweep line SWL[N].

The compensation voltage determining block 210 may determine the compensation voltage VC based on an average value of a data voltage group applied to the pixel-row. The compensation voltage determining block 210 may output the compensation voltage data VCD corresponding to the compensation voltage VC to the gate emission driver 300.

For example, a first data voltage group VDATAG[1] may be applied to the first pixel-row. The first data voltage group VDATAG[1] may include a plurality of data voltages applied to pixel circuits PX included in the first pixel-row. A first average value corresponding to an average value of the first data voltage group VDATAG[1] may be determined. The first average value may represent an average value of voltage levels of data voltages included in the first data voltage group VDATAG[1]. For example, the first pixel-row may include a first-first pixel circuit, a first-second pixel circuit and a first- third pixel circuit. When the first pixel-row includes the first-first pixel circuit, the first-second pixel circuit and a first-third pixel circuit, the first data voltage group VDATAG[1] may include a first-first data voltage applied to the first-first pixel circuit, a first-second data voltage applied to the first-second pixel circuit and a first-third data voltage applied to the first-third pixel circuit. In this case, the first average value may be an average value of the voltage level of the first-first data voltage, the voltage level of the first-second data voltage, and the voltage level of the first-third data voltage.

For example, a second data voltage group VDATAG[2] may be applied to the second pixel-row. The second data voltage group VDATAG[2] may include a plurality of data voltages applied to pixel circuits PX included in the second pixel-row. A second average value corresponding to an average value of the second data voltage group VDATAG[2] may be determined. The second average value may represent an average value of voltage levels of data voltages included in the second data voltage group VDATAG[2]. For example, the second pixel-row may include a second-first pixel circuit, a second-second pixel circuit and a second- third pixel circuit. When the second pixel-row includes the second-first pixel circuit, the second-second pixel circuit and a second-third pixel circuit, the second data voltage group VDATAG[2] may include a second-first data voltage applied to the second-first pixel circuit, a second-second data voltage applied to the second-second pixel circuit and a second-third data voltage applied to the second-third pixel circuit. In this case, the second average value may be an average value of the voltage level of the second-first data voltage, the voltage level of the second-second data voltage, and the voltage level of the second-third data voltage.

For example, a third data voltage group VDATAG[3] may be applied to the third pixel-row. The third data voltage group VDATAG[3] may include a plurality of data voltages applied to pixel circuits PX included in the third pixel-row. A third average value corresponding to an average value of the third data voltage group VDATAG[3] may be determined. The third average value may represent an average value of voltage levels of data voltages included in the third data voltage group VDATAG[3]. For example, the third pixel-row may include a third-first pixel circuit, a third-second pixel circuit and a third- third pixel circuit. When the third pixel-row includes the third-first pixel circuit, the third-second pixel circuit and a third-third pixel circuit, the third data voltage group VDATAG[3] may include a third-first data voltage applied to the third-first pixel circuit, a third-second data voltage applied to the third-second pixel circuit and a third-third data voltage applied to the third-third pixel circuit. In this case, the third average value may be an average value of the voltage level of the third-first data voltage, the voltage level of the third-second data voltage, and the voltage level of the third-third data voltage.

In an embodiment, the compensation voltage VC may be determined based on the difference between the average values.

For example, a first compensation voltage applied to the first sweep line SWL[1] may be determined based on the difference between the first average value and the second average value. The first compensation voltage may be determined based on a value obtained by multiplying a first difference value, which is the difference between the first average value and the second average value, by a first compensation constant. For example, the first difference value may be a value obtained by subtracting the first average value from the second average value. The first compensation constant may be determined based on a capacitance of a first compensation capacitor connected to the first sweep line SWL[1]. For example, the first compensation constant may be set based on the capacitance of the first compensation capacitor connected to the first sweep line SWL[1]. The first compensation voltage may have a value which is opposite to a value obtained by multiplying the first difference value by the first compensation constant.

For example, a second compensation voltage applied to the second sweep line SWL[2] may be determined based on the difference between the second average value and the third average value. The second compensation voltage may be determined based on a value obtained by multiplying a second difference value, which is the difference between the second average value and the third average value, by a second compensation constant. For example, the second difference value may be a value obtained by subtracting the second average value from the third average value. The second compensation constant may be determined based on a capacitance of a second compensation capacitor connected to the second sweep line SWL[2]. For example, the second compensation constant may be set based on the capacitance of the second compensation capacitor connected to the second sweep line SWL[2]. The second compensation voltage may have a value which is opposite to a value obtained by multiplying the second difference value by the third compensation constant.

For example, a N-th compensation voltage VC[N] applied to the N-th sweep line SWL[N] may be determined based on a difference between the N-th average value and an N+1-th average value. The N-th compensation voltage may be determined based on a value obtained by multiplying an N-th difference value, which is the difference between the N-th average value and the N+1-th average value, by an N-th compensation constant. For example, the N-th difference value may be a value obtained by subtracting the N-th average value from the N+1-th average value. The N-th compensation constant may be determined based on the capacitance of the N-th compensation capacitor CC[N] connected to the N-th sweep line SWL[N]. For example, the N-th compensation constant may be set based on the capacitance of the N-th compensation capacitor CC[N] connected to the N-th sweep line SWL[N]. The N-th compensation voltage VC[N] may have a value which is opposite a value obtained by multiplying N-th difference value by the N-th compensation constant.

In an embodiment, the compensation voltage VC may be determined based on the average values.

For example, the first compensation voltage applied to the first sweep line SWL[1] may be determined based on the first average value. The first compensation voltage may be determined based on a value obtained by multiplying the first average value by the first compensation constant. The first compensation voltage may have a value which is opposite to the value obtained by multiplying the first average value by the first compensation constant.

For example, the second compensation voltage applied to the second sweep line SWL[2] may be determined based on the second average value. The second compensation voltage may be determined based on a value obtained by multiplying the second average value by the second compensation constant. The second compensation voltage may have a value which is opposite to the value obtained by multiplying the second average value by the second compensation constant.

For example, the third compensation voltage applied to the third sweep line SWL[3] may be determined based on the third average value. The third compensation voltage may be determined based on a value obtained by multiplying the third average value by the third compensation constant. The third compensation voltage may have a value which is opposite to the value obtained by multiplying the third average value by the third compensation constant.

For example, the N-th compensation voltage applied to the N-th sweep line SWL[N] may be determined based on the N-th average value. The N-th compensation voltage may be determined based on a value obtained by multiplying the N-th average value by the N-th compensation constant. The N-th compensation voltage may have a value which is opposite to the value obtained by multiplying the N-th average value by the N-th compensation constant.

In the present embodiment, the compensation voltage VC may be determined based on the average value of the data voltage group. The compensation voltage VC may be applied to the sweep line. Accordingly, an influence of the parasitic voltage VP due to the change in the data voltage VDATA may be reduced. For example, the influence of the parasitic voltage VP may be reduced based on the compensation voltage VC. Since the influence of the parasitic voltage VP may be reduced based on the compensation voltage VC, the signal stability and signal reliability of the sweep signal SW may be improved. Accordingly, the display quality of the display panel 100 may be effectively improved.

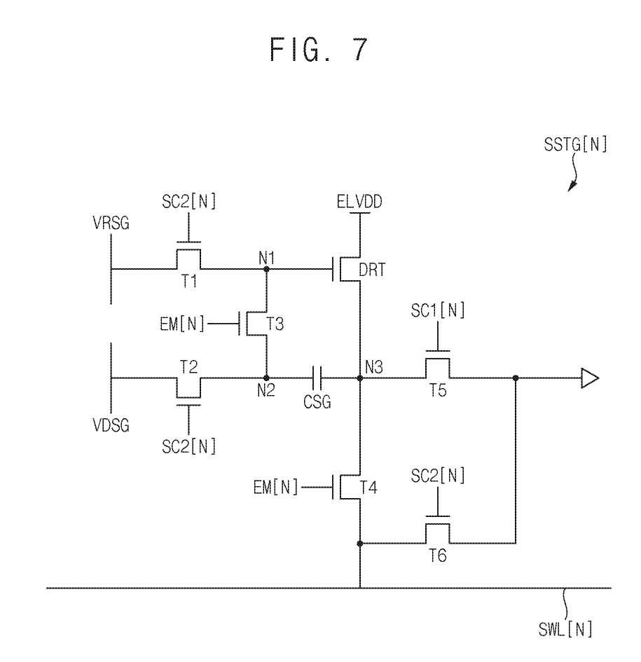

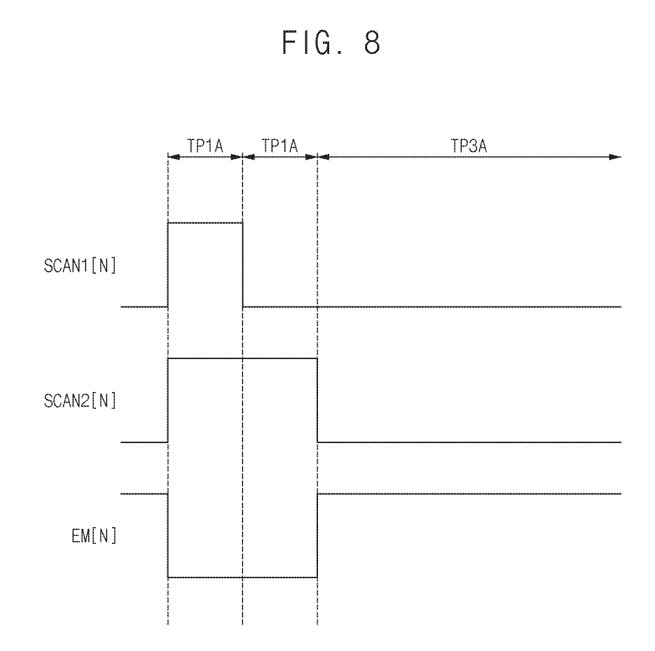

FIG. 7 is a circuit diagram illustrating an example of an N-th sweep stage SSTG[N] of FIG. 5. FIG. 8 is a circuit diagram illustrating an example of signals applied to an N-th sweep stage SSTG[N] of FIG. 7.

Referring to FIG. 7, the N-th sweep stage SSTG[N] may include first to sixth transistors T1 to T6, a sweep driving transistor DRT and a first capacitor CSG.

A first transistor T1 may include a control electrode for receiving a second-N-th scan signal SC2[N], a first electrode for receiving a reference voltage VRSG and a second electrode connected to a first node N1. The first transistor T1 may apply the reference voltage VRSG to the first node N1 in response to the second-N-th scan signal SC2[N].

The second transistor T2 may include a control electrode for receiving the second-N-th scan signal SC2[N], a first electrode for receiving a sweep data voltage VDSG and a second electrode connected to a second node N2. The second transistor T2 may apply the sweep data voltage VDSG to the second node N2 in response to the second-N-th scan signal SC2[N].

The third transistor T3 may include a control electrode for receiving an N-th emission signal EM[N], a first electrode connected to the first node N1 and a second electrode connected to the second node N2. The third transistor T3 may connect the first node N1 and the second node N2 in response to the N-th emission signal EM[N].

The first capacitor CSG may include a first electrode connected to the second node N2 and a second electrode connected to a third node N3.

The sweep driving transistor DRT may include a control electrode connected to the first node N1, a first electrode for receiving a first power voltage ELVDD and a second electrode connected to the third node N3. The sweep driving transistor DRT may generate a sweep driving current based on a voltage of the first node N1. The sweep driving transistor DRT may apply the sweep driving current to the third node N3.

The fourth transistor T4 may include a control electrode for receiving the N-th emission signal EM[N], a first electrode connected to the third node N3 and a second electrode connected to the N-th sweep line SWL[N]. The fourth transistor T4 may output the sweep driving current to the N-th sweep line SWL[N] in response to the N-th emission signal EM[N]. For example, the sweep driving current (or voltage) may be the N-th sweep signal. A slope of the N-th sweep signal may be determined based on the sweep data voltage VDSG.

The fifth transistor T5 may include a control electrode for receiving the first-N-th scan signal SC1[1], a first electrode for receiving a ground voltage and a second electrode connected to the third node N3. The fifth transistor T5 may apply the ground voltage to the third node N3 in response to the first-N-th scan signal SC1[1].

The sixth transistor T6 may include a control electrode for receiving the second-N-th scan signal SC2[N], a first electrode for receiving the ground voltage and a second electrode connected to the N-th sweep line SWL[N]. The sixth transistor T6 may apply the ground voltage to the N-th sweep line SWL[N] in response to the second-N-th scan signal SC2[N].

A period in which the N-th sweep stage SSTG[N] is driven may include first to third periods TP1A to TP3A.

In the first period TP1A, the first-N-th scan signal SC1[1] may have an activation level, the second-N-th scan signal SC2[N] may have an activation level, and the N-th emission signal EM[N] may have an inactivation level. The activation level may refer to a voltage level at which the transistor is turned on. The inactivation level may refer to a voltage level at which the transistor is turned off.

In the first period TP1A, the N-th sweep line SWL[N] may be initialized to the ground voltage. In the first period TP1A, the reference voltage VRSG may be applied to the first node N1. In the first period TP1A, the sweep data voltage VDSG may be applied to the second node N2. In the first period TP1A, the third node N3 may be initialized to the ground voltage.

In the second period TP2A, the first-N-th scan signal SC1[1] may have an inactivation level, the second-N-th scan signal SC2[N] may have an activation level, and the N-th emission signal EM[N] may have an inactivation level.

In the third period TP3A, the first-N-th scan signal SC1[1] may have an inactivation level, the second-N-th scan signal SC2[N] may have an inactivation level, and the N-th emission signal EM[N] may have an activation level. In the third period TP3A, the sweep driving current may be outputted.

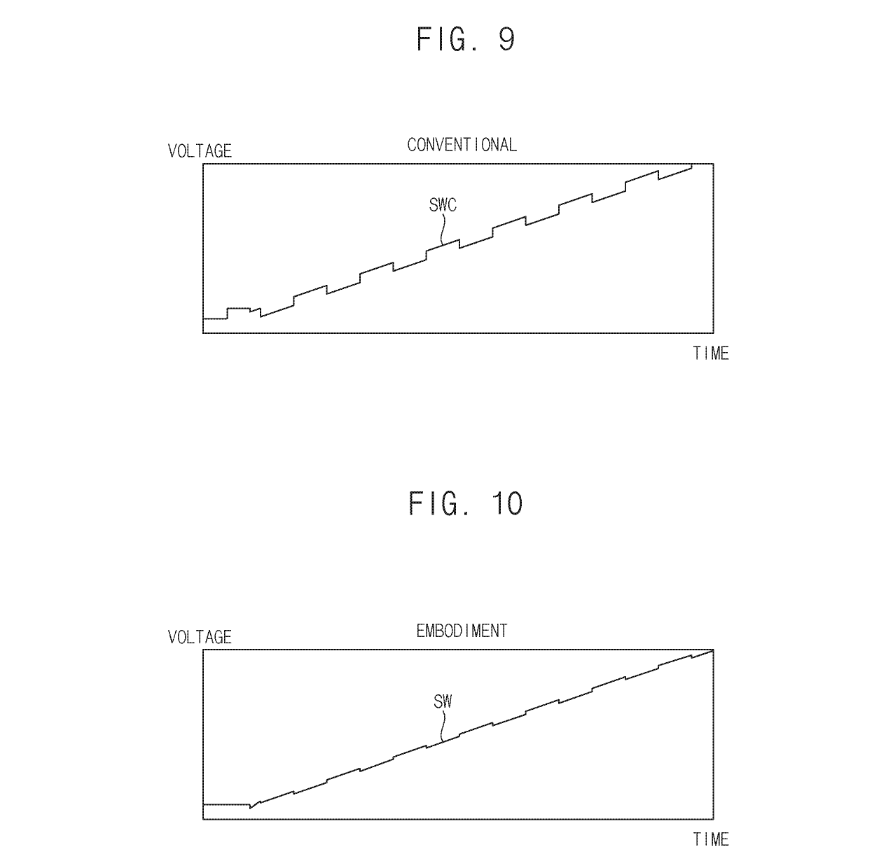

FIG. 9 is a graph illustrating a sweep signal SW according to a comparative example. FIG. 10 is a graph illustrating a sweep signal SW applied to a pixel circuit PX of FIG. 1.

Referring to FIGS. 1, 9, and 10, a sweep signal SWC according to the comparative example may have deteriorated output stability based on changes in the data voltage. For example, a parasitic voltage may be reflected in the sweep signal SWC according to the comparative example based on parasitic capacitance.

In contrast, the sweep signal SW according to the present embodiment may have a value based on the compensation voltage VC. The compensation voltage VC may be determined based on the average value of the data voltage group. The compensation voltage VC may be applied to the sweep line. Accordingly, the influence of the parasitic voltage VP due to a change in the data voltage VDATA may be reduced. For example, the influence of the parasitic voltage VP may be reduced based on the compensation voltage VC. Since the influence of the parasitic voltage VP may be reduced based on the compensation voltage VC, the signal stability and signal reliability of the sweep signal SW may be improved. Accordingly, the display quality of the display panel 100 may be effectively improved.

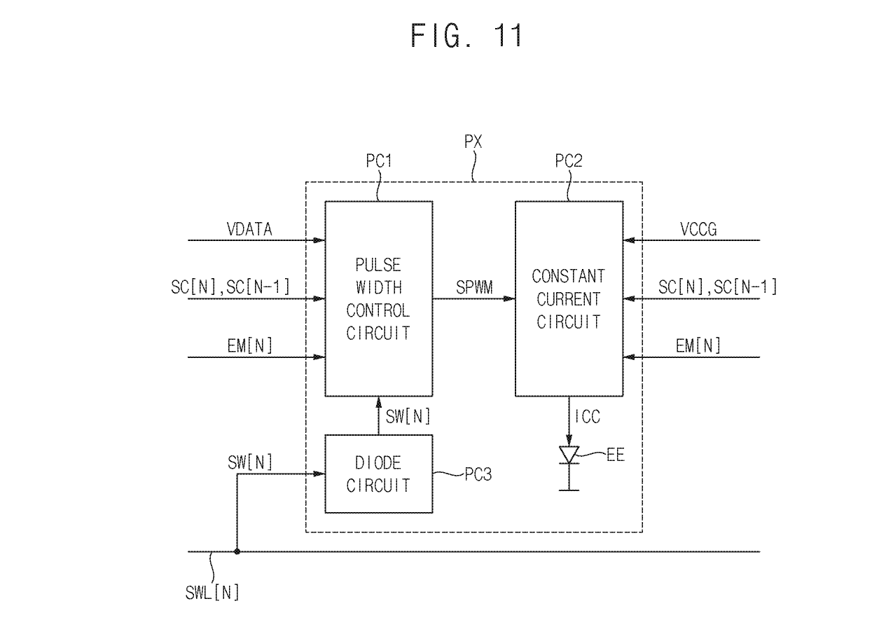

FIG. 11 is a circuit diagram illustrating an example of a pixel circuit PX of FIG. 1.

Referring to FIGS. 1-11, the pixel circuit PX may include a pulse width control circuit PC1, a constant current circuit PC2, a diode circuit PC3 and a light emitting element EE. For example, the pulse width control circuit PC1 may be referred to as the first circuit. For example, the constant current circuit PC2 may be referred to as the second circuit. For example, the diode circuit PC3 may be referred to as the third circuit.

The pixel circuit PX may include the pulse width control circuit PC1 which generates a pulse width control signal SPWM based on the sweep signal SW[N] applied through the sweep line SWL[N], the data voltage VDATA, the first scan signals SC[N] and SC[N-1] and the N-th emission signal EM[N], a constant current circuit PC2 which generates a light emission current ICC based on a constant current voltage VCCG and the pulse width control signal SPWM, and a light emitting element EE which emits light based on the light emission current ICC.

For example, the pixel circuit PX may be located in an N-th pixel-row among a plurality of pixel-rows of the display panel 100, where N is an integer greater than or equal to 2. The pulse width control circuit PC1 of the pixel circuit PX may store the data voltage VDATA in response to the scan signal SC[N-1] for the N-1-th pixel-row. Meanwhile, although FIG. 11 illustrates an example in which the pulse width control circuit PC1 receives the scan signal SC[N-1] for the N-1-th pixel-row, in other embodiment, the pulse width control circuit PC1 may receive the scan signal SC[N] for the N-th pixel-row together with or instead of the scan signal SC[N-1] for the N-1-th pixel row. In this case, the pulse width control circuit PC1 may store the data voltage VDATA in response to the scan signal SCAN[n] for the N-th pixel-row, but is not limited thereto. During a sweep period in which the N-th emission signal EM[N] has an activation level (e.g., a low level), the pulse width control circuit PC1 may receive the sweep signal SW[N] which gradually increases through the sweep line SWL[N]. Additionally, the pulse width control circuit PC1 may generate the pulse width control signal SPWM having an activation level during a period (e.g., an emission period) from a start time of the sweep period to a time when the sweep signal SW[N] becomes the data voltage VDATA. Accordingly, the data voltage VDATA may be determined according to the data signal DATA for the pixel circuit PX, and the time length of the period (e.g., the emission period) in which the pulse width control signal SPWM has the activation level may be controlled according to the data voltage VDATA. For example, as the voltage level of the data voltage VDATA increases, the time length of the period (e.g., the light emitting period) in which the pulse width control signal SPWM has the activation level may increase, but is not limited thereto.

The constant current circuit PC2 may store the constant current voltage VCCG in response to the scan signal SC[N] for the N-th pixel row. In an embodiment, the constant current voltage VCCG may be substantially the same voltage, regardless of the data signal DATA for the plurality of pixel circuits PX. Additionally, the voltage level of the constant current voltage VCCG may be determined so that the constant current circuit PC2 provides a light emission current ICC having a desired target current level to the light emitting element EE. During the sweep period in which the N-th emission signal EM[N] has the activation level, the constant current circuit PC2 may receive the pulse width control signal SPWM from the pulse width control circuit PC1 and generate the light emission current ICC in response to the pulse width control signal SPWM having the activation level. That is, the constant current circuit PC2 may provide a light emitting current ICC to the light emitting element EE during a period (e.g., the light emitting period) in which the pulse width control signal SPWM has the activation level.

The light emitting element EE may emit light based on the light emission current ICC having the target current level provided from the constant current circuit PC2. Additionally, the time length of the period in which the pulse width control signal SPWM has the activation level is controlled according to the data voltage VDATA, and the constant current circuit PC2 applies the light emitting current ICC to the light emitting element EE during the period in which the pulse width control signal SPWM has the activation level, and the light emitting element EE emits light during the period in which the constant current circuit PC2 provides the light emitting current ICC, so the time length of the period in which the light emitting element EE emits light (e.g., the light emitting period) may be determined according to the voltage level of the data voltage VDATA. Thus, the pixel circuit PX may drive the light emitting element EE in a PWM(Pulse Width Modulation) method that adjusts the time length of the emission period according to the data voltage VDATA. In an embodiments, the light emitting element EE may be, but is not limited to, a micro-light-emitting diode (“micro-LED”). In other embodiments, the light emitting element EE may be an organic light-emitting diode (“OLED”), a nano light-emitting diode (“nano-LED”), a quantum dot (“QD”) light-emitting diode, an inorganic light-emitting diode, or any other suitable light-emitting element.

In an embodiment, the diode circuit PC3 may receive the N-th sweep signal SW[N] from the N-th sweep line SWL[N]. The diode circuit PC3 may receive the N-th sweep signal SW[N] from the N-th sweep line SWL[N] and output the N-th sweep signal SW[N] to the pulse width control circuit PC1. The diode circuit PC3 may include a diode element. Since the diode circuit PC3 may include the diode element, current may not be applied from the pulse width control circuit PC1 to the N-th sweep line SWL[N]. Accordingly, even if a parasitic voltage VP is generated based on a change in the data voltage VDATA, the sweep signal SW applied to the pulse width control circuit PC1 may be stably applied. Accordingly, the output stability of the sweep signal SW applied to the pulse width control circuit PC1 may be improved. Accordingly, the display quality of the display panel 100 may be effectively improved.

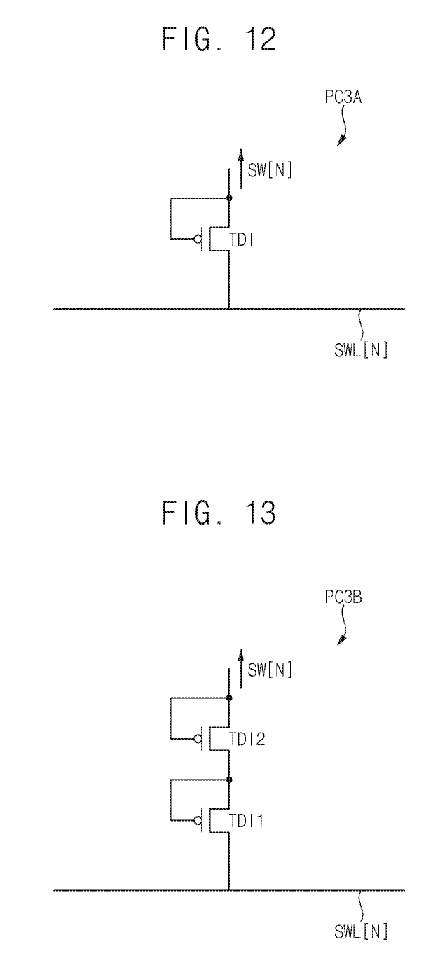

FIG. 12 is a circuit diagram illustrating an example of a diode circuit PC3 of FIG. 11.

Referring to FIGS. 1-12, the diode element included in a diode circuit PC3A may be a diode transistor TDI.

The diode transistor TDI may include a control electrode, a first electrode connected to the N-th sweep line SWL[N] and a second electrode connected to the control electrode. The second electrode of the diode transistor TDI may output the N-th sweep signal SW[N].

In the present embodiment, since the diode circuit PC3 may include a diode element, current may not be applied from the pulse width control circuit PC1 to the N-th sweep line SWL[N]. Accordingly, even if a parasitic voltage VP is generated based on a change in the data voltage VDATA, the sweep signal SW applied to the pulse width control circuit PC1 may be applied stably. Accordingly, the output stability of the sweep signal SW applied to the pulse width control circuit PC1 may be improved. Accordingly, the display quality of the display panel 100 may be effectively improved.

FIG. 13 is a circuit diagram illustrating an example of a diode circuit PC3 of FIG. 11.

Referring to FIGS. 1-13, the diode element included in a diode circuit PC3B may include a plurality of diode transistors. In an embodiment, the plurality of diode transistors may be connected in series. For example, the diode element may include a first diode transistor TDI1 and a second diode transistor TDI2.

The first diode transistor TDI1 may include a control electrode, a first electrode connected to the N-th sweep line SWL[N] and a second electrode connected to the control electrode of the first diode transistor TDI1.

The second diode transistor TDI2 may include a control electrode, a first electrode connected to the second electrode of the first diode transistor TDI1 and a second electrode connected to the control electrode of the second diode transistor TDI1. The second electrode of the second diode transistor TDI2 may output the N-th sweep signal SW[N].

In the present embodiment, since the diode circuit PC3 may include a diode element, current may not be applied from the pulse width control circuit PC1 to the N-th sweep line SWL[N]. Accordingly, even if the parasitic voltage VP is generated based on a change in the data voltage VDATA, the sweep signal SW applied to the pulse width control circuit PC1 may be applied stably. Accordingly, the output stability of the sweep signal SW applied to the pulse width control circuit PC1 may be improved. Accordingly, the display quality of the display panel 100 may be effectively improved.

Additionally, the diode element may include a plurality of diode transistors. Accordingly, the output stability of the sweep signal SW applied to the pulse width control circuit PC1 may be further improved. Accordingly, the display quality of the display panel 100 may be further effectively improved.

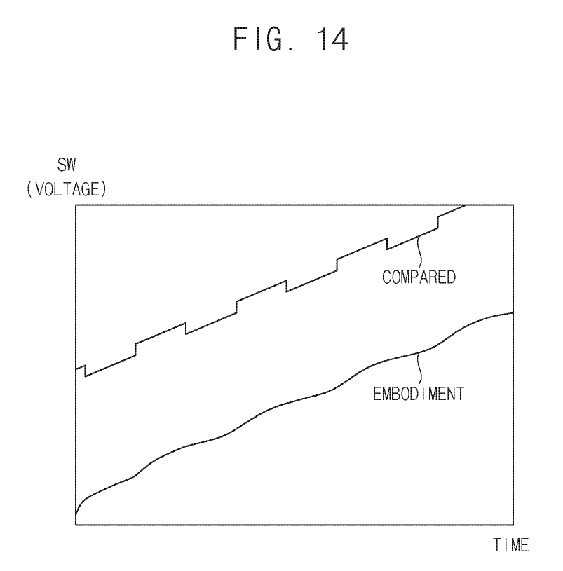

FIG. 14 is a graph illustrating a sweep signal SW according to a comparative example and a sweep signal SW applied to a pixel circuit PX of FIG. 1.

Referring to FIGS. 1, 11 and 14, the sweep signal according to the comparative example may have deteriorated output stability based on changes in the data voltage. For example, a parasitic voltage may be reflected in the sweep signal according to the comparative example based on parasitic capacitance.

In contrast, the pixel circuit PX according to the present embodiment may include a diode circuit PC3. The diode circuit PC3 may include a diode element. Accordingly, the influence of the parasitic voltage VP due to a change in the data voltage VDATA may be reduced. Since the influence of the parasitic voltage VP may be reduced, the signal stability and signal reliability of the sweep signal SW applied to the pulse width control circuit PC1 may be improved. Accordingly, the display quality of the display panel 100 may be effectively improved.

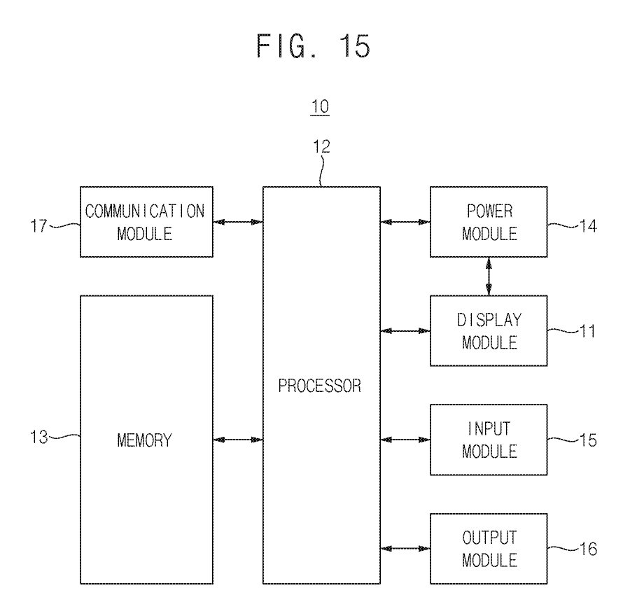

FIG. 15 is a block diagram illustrating an electronic device 10 according to embodiments of the present invention.

Referring to FIG. 15, an electronic device 10 according to an embodiment may include a display module 11, a processor 12, a memory 13 and a power module 14.

The processor 12 may include at least one of a central processing unit (CPU), an application processor (AP), a graphic processing unit (GPU), a communication processor (CP), an image signal processor (ISP), and a controller. The processor 12 may output the input control signal CONT of FIG. 1.

The memory 13 may store data information necessary for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power required for the operation of the electronic device 10. In an embodiment, the power module 14 may be the voltage generator 700 of FIG. 1.

The electronic device 10 may further include an input module 15, a non-image output module 16 and/or a communication module 17.

The input module 15 may provide input information to the processor 12 and/or the display module 11. The input module 15 may include various sensor modules as well as physical buttons, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the processor 12 and provide the information to the user. Examples of the non-image output module 16 may include an audio module, a haptic module, a light-emitting module, etc., and may include other functional modules unique to electronic devices (e.g., a cooling module of a refrigerator, etc.).

The communication module 17 may be a module that is responsible for transmitting and receiving information between the electronic device 10 and an external device, and may include a receiving unit and a transmitting unit. The communication module 17 may include various wireless communication modules such as a mobile communication module, a Wi-Fi module, a Bluetooth module, or various wired communication modules.

At least one of the components of the electronic device 10 described above may be included in the display device according to the embodiments described above. Additionally, some of the individual modules functionally included in one module may be included in the display device, and other may be provided separately from the display device. For example, the display device may include the display module 11, and the processor 12, the memory 13, and the power module 14 may be provided in the form of other devices within the electronic device 10 other than the display device.

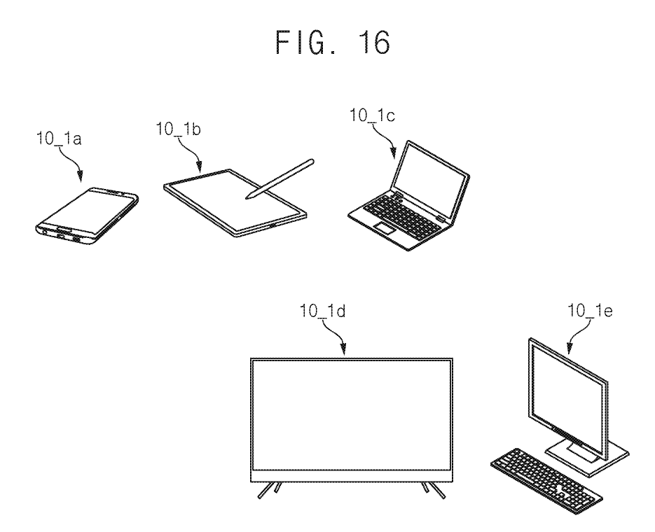

FIGS. 16-18 are schematic diagrams illustrating an electronic device according to embodiments.

Referring to FIG. 16, a smartphone 10_1a, a tablet PC 10_1b, a laptop 10_1c, a TV 10_1d, and a desk monitor 10_1e are examples of electronic devices.

The smartphone 10_1a may include an input module such as a touch sensor and a communication module in addition to the display module 11. The smartphone 10_1a may process information received through the communication module or other input modules and display the information through the display module of the display device.

In the case of tablet PC 10_1b, laptop 10_1c, TV 10_1d, and desk monitor 10_1e, may include a display module and an input module similar to the smartphone 10_1a, and in some cases, may further include a communication module.

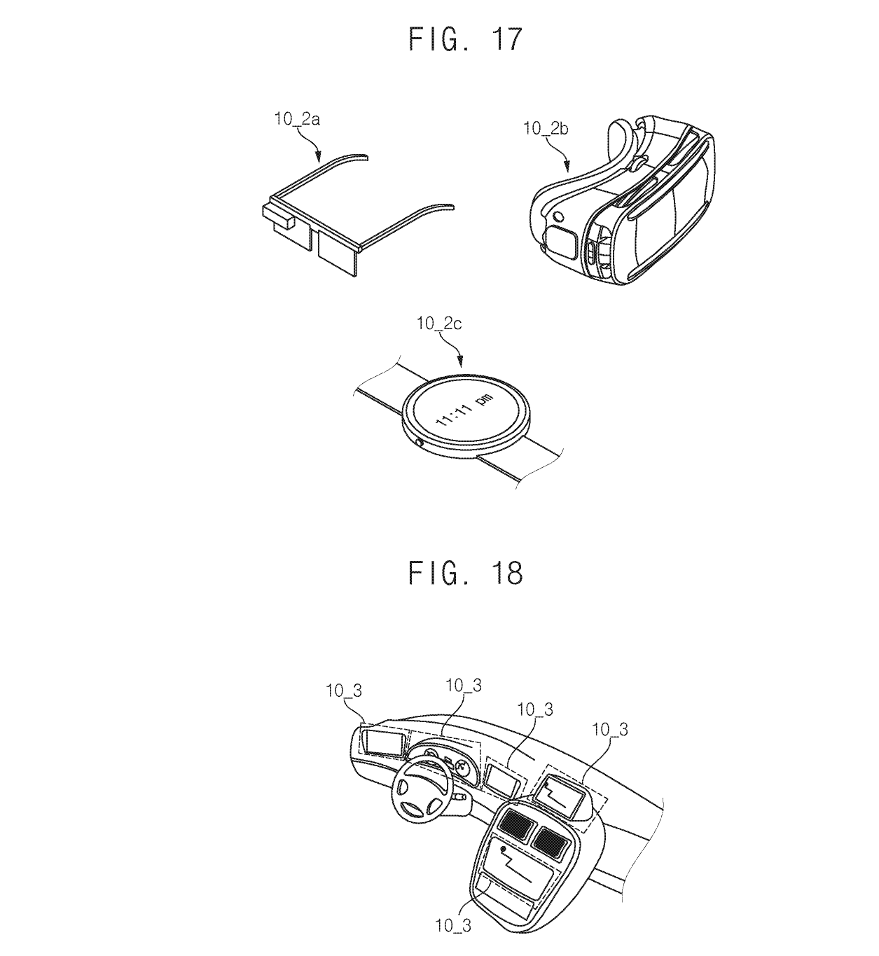

Referring to FIG. 17, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module which emits a display image and a reflector which reflects the emitted display image and provides it to the user's eyes, thereby providing a virtual reality or augmented reality screen to the user.

The smartwatch 10_2c may include a biometric sensor as an input device and may provide biometric information recognized by the biometric sensor to the user through a display module.

Referring to FIG. 18, an electronic device including a display module may be applied to a vehicle. For example, the electronic device 10_3 may be applied to a dashboard, center fascia, etc. of a vehicle, or may be applied to a CID (Center Information Display) placed on a dashboard of a vehicle or a room mirror display replacing a side mirror.

Although not illustrated, electronic devices to which the display device according to the embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, it may be applied to electronic devices, such as smart windows or transparent display devices that display a background and a display image together. The type of electronic device according to the embodiment is not limited by the examples, and application to other various electronic devices that are not illustrated may also be possible.

The display device according to the embodiments may be applied to a display device included in a computer, a notebook, a mobile phone, a smart phone, a smart pad, a PMP, a PDA, an MP3 player, or the like.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A display device comprising:
a display panel including a pixel circuit;
a gate emission driver, which outputs a gate emission signal to the pixel circuit;
a sweep signal generator, which generates a sweep signal based on the gate emission signal;
a data driver, which applies a data voltage to the pixel circuit; and
a driving controller, which controls the gate emission driver, the sweep signal generator and the data driver,
wherein the sweep signal generator outputs the sweep signal to the pixel circuit through a sweep line,
wherein the sweep line is connected to a compensation capacitor,
wherein the compensation capacitor receives a compensation voltage, and
wherein the compensation voltage is generated based on the data voltage.

2. The display device of claim 1, wherein the compensation voltage is generated based on an average value of a data voltage group applied to a pixel-row.

3. The display device of claim 1, wherein the display panel includes first to N-th pixel-rows, and N is a natural number greater than 1, and
wherein the compensation voltage is generated based on a first average value of a first data voltage group applied to the first pixel-row and a second average value of a second data voltage group applied to the second pixel-row.

4. The display device of claim 3, wherein the compensation voltage is generated based on a difference between the first average value and the second average value.

5. The display device of claim 4, wherein the compensation voltage is generated based on a value obtained by multiplying a compensation constant and the difference between the first average value and the second average value.

6. The display device of claim 5, wherein the compensation constant is determined based on a capacitance of the compensation capacitor.

7. The display device of claim 3, wherein the display panel further includes first to N-th sweep lines,
wherein the first sweep line is connected to the first pixel-row, the second sweep line is connected to the second pixel-row, and the third sweep line is connected to the third pixel-row,
wherein the first sweep line receives a first compensation voltage through a first compensation capacitor, the second sweep line receives a second compensation voltage through a second compensation capacitor, and the third sweep line receives a third compensation voltage through a third compensation capacitor,
wherein the first compensation voltage is generated based on the first average value and the second average value, and
wherein the second compensation voltage is generated based on a third average value of a third data voltage group applied to the third pixel-row and the second average value.

8. The display device of claim 1, wherein the display panel includes first to N-th pixel-rows and first to N-th sweep lines, and N is a natural number greater than 1,
wherein the first sweep line is connected to the first pixel-row, and the second sweep line is connected to the second pixel-row,
wherein the first sweep line receives a first compensation voltage through a first compensation capacitor, and the second sweep line receives a second compensation voltage through a second compensation capacitor,
wherein the first compensation voltage is a first average value of a first data voltage group applied to the first pixel-row, and
wherein the second compensation voltage is a second average value of a second data voltage group applied to the second pixel-row.

9. The display device of claim 1, wherein the driving controller outputs compensation voltage data to the gate emission driver based on the data voltage, and
wherein the gate emission driver outputs the compensation voltage to the sweep line.

10. The display device of claim 1, wherein the pixel circuit includes:
a first circuit which outputs a pulse control signal based on the gate emission signal and the sweep signal;
a second circuit which generates a driving current based on the pulse control signal and the gate emission signal;
a third circuit which is connected to the sweep line and outputs the sweep signal to the first circuit; and
a light emitting element which emits light based on the driving current, and
wherein the third circuit includes a diode element.

11. A display device comprising:
a display panel including a pixel circuit;
a gate emission driver, which outputs a gate emission signal to the pixel circuit;
a sweep signal generator, which generates a sweep signal based on the gate emission signal;
a data driver, which applies a data voltage to the pixel circuit; and
a driving controller, which controls the gate emission driver, the sweep signal generator and the data driver,
wherein the sweep signal generator outputs the sweep signal to the pixel circuit through a sweep line,
wherein the pixel circuit includes:
a first circuit which outputs a pulse control signal based on the gate emission signal and the sweep signal;
a second circuit which generates a driving current based on the pulse control signal and the gate emission signal;
a third circuit which is connected to the sweep line and outputs the sweep signal to the first circuit; and
a light emitting element which emits light based on the driving current, and
wherein the third circuit includes a diode element.

12. The display device of claim 11, wherein the diode element is a diode transistor,
wherein the diode transistor includes a control electrode, a first electrode connected to the sweep line and a second electrode connected to the control electrode, and
wherein the second electrode outputs the sweep signal.

13. The display device of claim 11, wherein the diode element includes a first diode transistor and a second diode transistor, and
wherein the first diode transistor and the second diode transistor are connected in series.

14. The display device of claim 13, wherein the first diode transistor includes a control electrode, a first electrode connected to the sweep line and a second electrode connected to the control electrode of the first diode transistor,
wherein the second diode transistor includes a control electrode, a first electrode connected to the second electrode of the first diode transistor and a second electrode connected to the control electrode of the second diode transistor, and
wherein the second electrode of the second diode transistor outputs the sweep signal.

15. An electronic device comprising:
a display panel including a pixel circuit;
a gate emission driver, which outputs a gate emission signal to the pixel circuit;
a sweep signal generator, which generates a sweep signal based on the gate emission signal;
a data driver, which applies a data voltage to the pixel circuit;
a driving controller, which controls the gate emission driver, the sweep signal generator and the data driver based on an input control signal; and
a processor, which outputs the input control signal,
wherein the sweep signal generator outputs the sweep signal to the pixel circuit through a sweep line,
wherein the sweep line is connected to a compensation capacitor,
wherein the compensation capacitor receives a compensation voltage, and
wherein the compensation voltage is generated based on the data voltage.

16. The electronic device of claim 15, wherein the display panel includes first to N-th pixel-rows, and N is a natural number greater than 1, and
wherein the compensation voltage is generated based on a first average value of a first data voltage group applied to the first pixel-row and a second average value of a second data voltage group applied to the second pixel-row.

17. The electronic device of claim 16, wherein the compensation voltage is generated based on a difference between the first average value and the second average value.

18. The electronic device of claim 16, wherein the display panel further includes first to N-th sweep lines,
wherein the first sweep line is connected to the first pixel-row, the second sweep line is connected to the second pixel-row, and the third sweep line is connected to the third pixel-row,
wherein the first sweep line receives a first compensation voltage through a first compensation capacitor, the second sweep line receives a second compensation voltage through a second compensation capacitor, and the third sweep line receives a third compensation voltage through a third compensation capacitor,
wherein the first compensation voltage is generated based on the first average value and the second average value, and
wherein the second compensation voltage is generated based on a third average value of a third data voltage group applied to the third pixel-row and the second average value.

19. The electronic device of claim 15, wherein the display panel includes first to N-th pixel-rows and first to N-th sweep lines, and N is a natural number greater than 1,
wherein the first sweep line is connected to the first pixel-row, and the second sweep line is connected to the second pixel-row,
wherein the first sweep line receives a first compensation voltage through a first compensation capacitor, and the second sweep line receives a second compensation voltage through a second compensation capacitor,
wherein the first compensation voltage is a first average value of a first data voltage group applied to the first pixel-row, and
wherein the second compensation voltage is a second average value of a second data voltage group applied to the second pixel-row.

20. The electronic device of claim 15, wherein the pixel circuit includes:
a first circuit which outputs a pulse control signal based on the gate emission signal and the sweep signal;
a second circuit which generates a driving current based on the pulse control signal and the gate emission signal;
a third circuit which is connected to the sweep line and outputs the sweep signal to the first circuit; and
a light emitting element which emits light based on the driving current, and
wherein the third circuit includes a diode element.
